(19) United States
(12) Patent Application Publication
(10) Pub. No.: US 2025/0165098 A1
(43) Pub. Date: May 22, 2025

(54) COMMON-MODE INTERFERENCE ELIMINATION METHOD FOR SCANNING DETECTION DEVICE

(71) Applicant: GALAXYCORE SHANGHAI LIMITED CORPORATION, Shanghai (CN)

(72) Inventors: Chen MENG, Shanghai (CN); Fuzhong WANG, Shanghai (CN)

(73) Assignee: GALAXYCORE SHANGHAI LIMITED CORPORATION, Shanghai (CN)

(21) Appl. No.: 18/878,980

(22) PCT Filed: Jun. 29, 2023
(86) PCT No.: PCT/CN2023/103658

§ 371 Date: Dec. 26, 2024

(30) Foreign Application Priority Data
Jul. 1, 2022 (CN) 202210766135.3
Jul. 1, 2022 (CN) 202210766401.2

(51) Int. Cl. G06F 3/041; G06F 3/044; G06V 40/13

(52) U.S. Cl. CPC G06F 3/0418; G06F 3/04166; G06F 3/044; G06V 40/1306

(57) ABSTRACT

A common-mode interference elimination method for a scanning detection device is provided. When an M^{th} sub-period and an (M+1)^{th} sub-period respectively include scanning stages with same length and same scanning polarity, a scanning period of the scanning detection device is set to include N sub-periods that are (K+0.5) times a period of an interference signal, to make influence of the interference signal during a scanning process on a scanning result be self-cancelled. When the M^{th} sub-period and the (M+1)^{th} sub-period respectively include scanning stages with the same length and opposite scanning polarities, the scanning period of the scanning detection device is set to include N sub-periods that are K times the period of the interference signal, to make the influence of the interference signal during the scanning process on the scanning result be self-cancelled. M=1, 3 N−1, N is a positive even number, and K is a positive integer.

### CROSS-REFERENCE TO RELATED APPLICATIONS

The present application is a National Stage Application of PCT International Application No.: PCT/CN2023/103658 filed on Jun. 29, 2023, which claims priority to Chinese Patent Application 202210766401.2, filed in the China National Intellectual Property Administration on Jul. 1, 2022, and Chinese Patent Application 202210766135.3, filed in the China National Intellectual Property Administration on Jul. 1, 2022 the disclosures of which are incorporated herein by reference in their entirety.

### TECHNICAL FIELD

This disclosure generally relates to a technology field of scanning detection device, and more particularly, to a common-mode interference elimination method for a scanning detection device.

### BACKGROUND

As mobile terminals such as smart phones and tablet computers are applied more widely, users have higher requirements on product experience. At present, most mobile terminals typically use capacitive touch screens or capacitive fingerprint recognition devices. A working process of scanning detection devices such as capacitive touch screens or capacitive fingerprint recognition devices is to detect capacitance variation of a screen or a fingerprint recognition area that is touched by a user's finger through a certain scanning signal, to obtain touch position information or fingerprint image information of the user's finger.

When a mobile terminal is charged with a charger, the mobile terminal operates in a power supply system with common-mode interference. Common-mode interference refers to that potentials of a power supply and the ground change synchronously, while a potential of a detected object (finger) does not completely follow the synchronous change, which is equivalent to superimposing an interference signal on the detected object (finger). In this case, when the user uses a touch screen or fingerprint recognition, the common-mode interference signal will be superimposed on the scanning signal emitted by the touch screen or a fingerprint recognition device. Especially when a frequency of the interference signal is close to or equal to specific values, a resonance-like effect may be produced, causing an output result to be greatly interfered, thereby causing problems such as a touch failure and a fingerprint recognition failure.

At present, a commonly used method for handling the common-mode interference is to avoid the frequency where interference exists through frequency hopping technology, that is, adjusting a scanning frequency and selecting a scanning frequency that is far away from the frequency of the interference signal, so that the scanning frequency and the frequency of the interference signal are staggered, thereby reducing an interference change caused by the common-mode interference during an entire scanning period.

### SUMMARY

Embodiments of this disclosure provide a common-mode interference elimination method for a scanning detection device to solve problems caused by common-mode interference, such as touch failure or fingerprint recognition failure, and to improve performance of the scanning detection device.

An embodiment of this disclosure provides a common-mode interference elimination method for a scanning detection device, wherein in response to an M^{th} sub-period and an (M+1)^{th} sub-period respectively including scanning stages with a same length and a same scanning polarity, setting a scanning period of the scanning detection device to include N sub-periods that are (K+0.5) times a period of an interference signal, to make influence of the interference signal during a scanning process on a scanning result be self-cancelled, wherein M=1, 3, . . . , N−1, N is a positive even number, and K is a natural number; or in response to the M^{th} sub-period and the (M+1)^{th} sub-period respectively including scanning stages with the same length and opposite scanning polarities, setting the scanning period of the scanning detection device to include N sub-periods that are K times the period of the interference signal, to make the influence of the interference signal during the scanning process on the scanning result be self-cancelled, wherein M=1, 3, . . . , N−1, N is a positive even number, and K is a positive integer. The opposite scanning polarities mean that the scanning polarity of a scanning stage in the M^{th} sub-period is positive and the scanning polarity of a corresponding scanning stage in the (M+1)^{th} sub-period is negative, or, the scanning polarity of a scanning stage in the M^{th} sub-period is negative and the scanning polarity of a corresponding scanning stage in the (M+1)^{th} sub-period is positive, or, the scanning polarity of a scanning stage in the M^{th} sub-period is zero and the scanning polarity of a corresponding scanning stage in the (M+1)^{th} sub-period is zero. The same scanning polarity means that the scanning polarity of a scanning stage in the M^{th} sub-period and the scanning polarity of a corresponding scanning stage in the (M+1)^{th} sub-period are positive, or, the scanning polarity of a scanning stage in the M^{th} sub-period and the scanning polarity of a corresponding scanning stage in the (M+1)^{th} sub-period are negative, or, the scanning polarity of a scanning stage in the M^{th} sub-period and the scanning polarity of a corresponding scanning stage in the (M+1)^{th} sub-period is zero.

Optionally, the positive scanning polarity means that an output signal changes in a same direction as an input signal changes, the negative scanning polarity means that the output signal changes in an opposite direction as the input signal changes, and the zero scanning polarity means that the output signal does not change with the input signal.

Optionally, each of the sub-periods includes one or more scanning stages with a scanning polarity of positive, negative or zero.

Optionally, in the scanning stages with opposite scanning polarities, the amplitudes of the interference signal are equal and the signs of the interference signal are the same, to make the influence of the interference signal on the output cancel each other out.

Optionally, the scanning detection device is a capacitive touch screen or a capacitive fingerprint recognition device.

Optionally, in response to the scanning polarities being the same, the interference signal includes a fundamental wave and odd harmonics, and in response to the scanning polarities being opposite, the interference signal includes the fundamental wave, odd harmonics, and even harmonics.

Optionally, a scanning signal of the scanning detection device is a trapezoidal wave or a square wave.

Optionally, a waveform change direction of the scanning signal corresponds to the scanning polarity.

Optionally, each of the sub-periods includes an even number of trapezoidal wave edge slopes or an even number of square wave edge slopes, and two sub-periods having the same scanning polarities correspond to a same number of scanning polarity switches; or, each of the sub-periods includes an odd number of trapezoidal wave edge slopes or an odd number of square wave edge slopes, and two sub-periods having opposite scanning polarities correspond to a same number of scanning polarity switches.

Optionally, a waveform change direction of the scanning signal is unassociated with the scanning polarity.

An embodiment of this disclosure provides a common-mode interference elimination method for a scanning detection device, wherein a scanning period of the scanning detection device is set to include N sub-periods each of which is (K+0.5) times of a period of an interference signal, an M^{th} sub-period and an (M+1)^{th} sub-period respectively including scanning stages with a same length and a same scanning polarity, N is a positive even number, K is a natural number, and M=1, 3, . . . , and N−1, to make influence of the interference signal during a scanning process on a scanning result be self-cancelled; and the same scanning polarity means that the scanning polarity of a scanning stage in the M^{th} sub-period and the scanning polarity of a corresponding scanning stage in the (M+1)^{th} sub-period are positive, or, the scanning polarity of a scanning stage in the M^{th} sub-period and the scanning polarity of a corresponding scanning stage in the (M+1)^{th} sub-period are negative, or, the scanning polarity of a scanning stage in the M^{th} sub-period and the scanning polarity of a corresponding scanning stage in the (M+1)^{th} sub-period is zero.

Optionally, the positive scanning polarity means that an output signal changes in a same direction as an input signal changes, the negative scanning polarity means that the output signal changes in an opposite direction as the input signal changes, and the zero scanning polarity means that the output signal does not change with the input signal.

Optionally, each of the sub-periods includes one or more scanning stages with a scanning polarity of positive, negative or zero.

Optionally, in the scanning stages with the same scanning polarity, the interference signal has a same magnitude and opposite signs, to make influence of the interference signal on output cancel each other out.

Optionally, the scanning detection device is a capacitive touch screen or a capacitive fingerprint recognition device.

Optionally, the interference signal includes a fundamental wave and odd harmonics.

Optionally, a scanning signal of the scanning detection device is a trapezoidal wave or a square wave.

Optionally, a waveform change direction of the scanning signal corresponds to the scanning polarity.

Optionally, each of the sub-periods includes an even number of trapezoidal wave edge slopes or an even number of square wave edge slopes, and corresponds to a same number of scanning polarity switches.

Optionally, a waveform change direction of the scanning signal is unassociated with the scanning polarity.

An embodiment of this disclosure provides a common-mode interference elimination method for a scanning detection device, wherein a scanning period of the scanning detection device is set to include N sub-periods each of which is K times of a period of an interference signal, an M^{th} sub-period and an (M+1)^{th} sub-period respectively including scanning stages with a same length and a same scanning polarity, N is a positive even number, K is a natural number, and M=1, 3, . . . , and N−1, to make influence of the interference signal during a scanning process on a scanning result be self-cancelled; and the opposite scanning polarities mean that the scanning polarity of a scanning stage in the M^{th} sub-period is positive and the scanning polarity of a corresponding scanning stage in the (M+1)^{th} sub-period is negative, or, the scanning polarity of a scanning stage in the M^{th} sub-period is negative and the scanning polarity of a corresponding scanning stage in the (M+1)^{th} sub-period is positive, or, the scanning polarity of a scanning stage in the M^{th} sub-period is zero and the scanning polarity of a corresponding scanning stage in the (M+1)^{th} sub-period is zero.

Optionally, the positive scanning polarity means that an output signal changes in a same direction as an input signal changes, the negative scanning polarity means that the output signal changes in an opposite direction as the input signal changes, and the zero scanning polarity means that the output signal does not change with the input signal.

Optionally, each of the sub-periods includes one or more scanning stages with a scanning polarity of positive, negative or zero.

Optionally, in the scanning stages with opposite scanning polarities, the interference signal has a same magnitude and a same sign, to make influence of the interference signal on output cancel each other out.

Optionally, the scanning detection device is a capacitive touch screen or a capacitive fingerprint recognition device.

Optionally, the interference signal includes a fundamental wave and multiple harmonics.

Optionally, a scanning signal of the scanning detection device is a trapezoidal wave or a square wave.

Optionally, a waveform change direction of the scanning signal corresponds to the scanning polarity.

Optionally, each of the sub-periods includes an odd number of trapezoidal wave edge slopes or an odd number of square wave edge slopes, and corresponds to a same number of scanning polarity switches.

Optionally, the waveform change direction of the scanning signal is unassociated with the scanning polarity.

In the common-mode interference elimination method for the scanning detection device provided in the embodiments of this disclosure, in response to an M^{th} sub-period and an (M+1)^{th} sub-period respectively including scanning stages with a same length and a same scanning polarity, setting a scanning period of the scanning detection device to include N sub-periods that are (K+0.5) times a period of an interference signal, to make influence of the interference signal during a scanning process on a scanning result be self-cancelled, wherein M=1, 3, . . . , N−1, N is a positive even number, and K is a natural number; or in response to the M^{th} sub-period and the (M+1)^{th} sub-period respectively including scanning stages with the same length and opposite scanning polarities, setting the scanning period of the scanning detection device to include N sub-periods that are K times the period of the interference signal, to make the influence of the interference signal during the scanning process on the scanning result be self-cancelled, wherein M=1, 3, . . . , N−1, N is a positive even number, and K is a positive integer. In this manner, disadvantages caused by common-mode interference, such as touch failure or fingerprint recognition failure, may be alleviated, and usage performance of the scanning detection device, such as a capacitive touch screen or a capacitive fingerprint recognition device, may be improved. In this disclosure, no complex circuit structure is needed, and merely the scanning period and scanning polarity of the scanning detection device need to be reasonably set according to the period of the interference signal. This disclosure is applicable to common-mode interference systems of various interference frequencies, and has low implementation difficulty, low cost and good effect.

### BRIEF DESCRIPTION OF THE DRAWINGS

Other features, objects and advantages of this disclosure will become more clear from following detailed description of non-limiting embodiments with reference to accompanying drawings.

FIG. 1 shows a schematic diagram showing principle of a common-mode interference elimination method for a scanning detection device according to an embodiment.

FIG. 2 shows another schematic diagram showing principle of the common-mode interference elimination method for the scanning detection device according to the embodiment as shown in FIG. 1.

FIG. 3 shows a schematic diagram showing principle of a common-mode interference elimination method for a scanning detection device according to another embodiment.

FIG. 4 shows another schematic diagram showing principle of the common-mode interference elimination method for the scanning detection device according to the embodiment as shown in FIG. 3.

### DETAILED DESCRIPTION

In order to solve the problems in existing techniques, embodiments of this disclosure provide a common-mode interference elimination method for a scanning detection device.

In following specific description of preferred embodiments, reference will be made to accompanying drawings which constitute a part of this disclosure. The accompanying drawings show by way of example specific embodiments that can implement this disclosure. The illustrative embodiments are not intended to be exhaustive in enumerating all embodiments of this disclosure. It could be understood that other embodiments may be utilized, and structural or logical modifications may also be made without departing from the scope of this disclosure. Therefore, the following specific description is not restrictive, and the scope of this disclosure is limited by appended claims.

Detailed description is provided below with reference to specific embodiments.

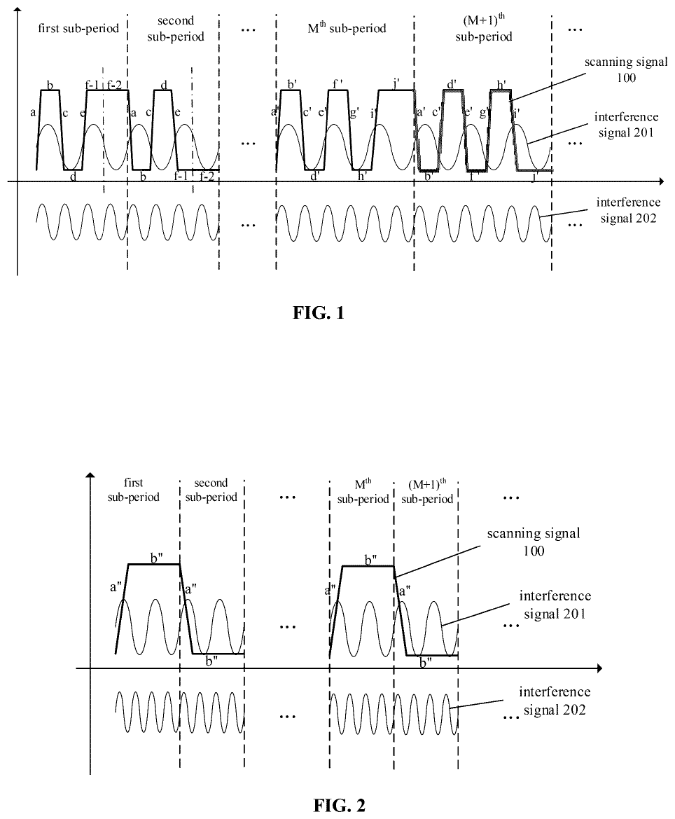

In an embodiment, as shown in FIG. 1, a common mode interference signal of a scanning detection device (e.g., a capacitive touch screen or a capacitive fingerprint recognition device) typically includes a fundamental wave and multiple harmonics. A fundamental wave 201 and a second harmonic 202 are shown in FIG. 1 as an example.

This disclosure provides a common-mode interference elimination method for a scanning detection device, wherein a scanning period of the scanning detection device is set to N sub-periods each of which is K times of a period of the interference signal, wherein N is a positive even number, and K is a positive integer. FIG. 1 illustrates the first sub-period, the second sub-period, the M^{th} sub-period, and the (M+1)^{th} sub-period as an example, M=1, 3, . . . , N−1. In the embodiment, the first sub-period and the second sub-period are respectively 2 times of a period of the fundamental wave 201 of the interference signal (or 4 times of the period of the second harmonic 202), and the M^{th} sub-period and the (M+1)^{th} sub-period are respectively 3 times of the period of the fundamental wave 201 of the interference signal (or 6 times of the period of the second harmonic 202). That is, lengths of the sub-periods may be different, and as long as they are integer multiples of the period of the interference signal, the method provided in this disclosure can be implemented.

Inventors of this disclosure have discovered through research and experiments that when the M^{th} sub-period and the (M+1)^{th} sub-period respectively include scanning stages with the same length and opposite scanning polarities, as the interference signal has the same magnitude and sign, influence of the interference signal during a scanning process on a scanning result can be self-cancelled. The opposite scanning polarities mean that when the scanning polarity of a scanning stage in the M^{th} sub-period is positive, the scanning polarity of a corresponding scanning stage in the (M+1)^{th} sub-period is negative; when the scanning polarity of a scanning stage in the M^{th} sub-period is negative, the scanning polarity of a corresponding scanning stage in the (M+1)^{th} sub-period is positive; or when the scanning polarity of a scanning stage in the M^{th} sub-period is zero, the scanning polarity of a corresponding scanning stage in the (M+1)^{th} sub-period is zero.

Specifically, the positive scanning polarity means that an output signal changes in a same direction as an input signal changes, that is, the output increases as the input increases, or the output decreases as the input decreases. The negative scanning polarities mean that the output signal changes in an opposite direction as the input signal changes, that is, the output decreases as the input increases, or the output increases as the input decreases. The zero scanning polarity means that the output signal does not change with the input signal, that is, the output change is independent of the input change, and a signal path is disconnected. In a circuit, it can typically be achieved by selecting a control switch. For example, if a switch between a signal obtained by scanning and a positive input terminal of a next-stage circuit is open, and a switch between the signal obtained by scanning and a negative input terminal of the next-stage circuit is closed, the scanning polarity is positive. Otherwise, if the switch between the signal obtained by scanning and the positive input terminal of the next-stage circuit is closed, and the switch between the signal obtained by scanning and the negative input terminal of the next-stage circuit is open, the scanning polarity is negative. If the switches between the signal obtained by scanning and the two input terminals of the next-stage circuit are closed, it is zero polarity. Each of the sub-periods nay include one or more scanning stages with the scanning polarity of positive, negative or zero. As long as the M^{th} sub-period and the (M+1)^{th} sub-period respectively include scanning stages with the same length and opposite scanning polarities, the method of this disclosure can be implemented.

As the M^{th} sub-period and the (M+1)^{th} sub-period are integer multiples of the period of the interference signal, and the M^{th} sub-period and the (M+1)^{th} sub-period respectively include the scanning stages with the same length and opposite scanning polarities, the interference signal has the same magnitude and sign in each corresponding stage, making the influence of the interference signal during the scanning process on the scanning result be self-cancelled, thereby alleviating disadvantages caused by common mode interference, such as touch failure or fingerprint recognition failure, and improving usage performance of the scanning detection device, such as a capacitive touch screen or a capacitive fingerprint recognition device.

Therefore, in this disclosure, no complex circuit structure is needed, and merely the scanning period and scanning polarity of the scanning detection device need to be reasonably set according to the period of the interference signal. This disclosure is applicable to common-mode interference systems of various interference frequencies, and has low implementation difficulty, low cost and good effect.

In an embodiment of this disclosure, the scanning polarity of the scanning detection device may be independent of a specific waveform of the scanning signal and a waveform change direction, that is, the scanning signal and the scanning polarity are controlled independently.

In another embodiment of this disclosure, the scanning polarity of the scanning detection device may also correspond to a waveform change direction of the scanning signal, that is, the waveform change of the scanning signal and the switch of the scanning polarity are performed synchronously. In the embodiment as shown in FIG. 1, taking a scanning signal 100 of a trapezoidal wave as an example (one skilled in the art could understand that the scanning signal 100 may alternatively be a square wave or other common waveforms, which is not limited in this disclosure), the waveform change direction of the scanning signal corresponding to the scanning polarity means that a rising edge slope (and a horizontal part thereafter) of a trapezoidal wave corresponds to the positive scanning polarity, and a falling edge slope (and a horizontal part thereafter) corresponds to the negative scanning polarity; or the rising edge slope (and the horizontal part thereafter) corresponds to the negative scanning polarity, and the falling edge slope (and the horizontal part thereafter) corresponds to the positive scanning polarity. Taking the first case mentioned above as an example, in the first sub-period shown in FIG. 1, the rising edge slope 1-a (and the horizontal part 1-b thereafter) and the rising edge slope 1-e (and the horizontal part 1-f-1 thereafter) correspond to the positive scanning polarity, the falling edge slope 1-c (and the horizontal part 1-d thereafter) corresponds to the negative scanning polarity, and the horizontal part 1-f-2 corresponds to zero scanning polarity. In the second sub-period, the falling edge slope 2-a (and the horizontal part 2-b thereafter) and the falling edge slope 2-e (and the horizontal part 2-f-1 thereafter) correspond to the negative scanning polarity, the rising edge slope 2-c (and the horizontal part 2-d thereafter) corresponds to the positive scanning polarity, and the horizontal part 2-f-2 corresponds to zero scanning polarity. In this manner, the first sub-period and the second sub-period respectively include scanning stages with the same length and opposite scanning polarities. In the M^{th} sub-period, the rising edge slope M-a′ (and the horizontal part M-b′ thereafter), the rising edge slope M-e′ (and the horizontal part M-f thereafter), and the rising edge slope M-i′ (and the horizontal part M-j′ thereafter) correspond to the positive scanning polarity, and the falling edge slope M-c′ (and the horizontal part M-d′ thereafter), and the falling edge slope M-g′ (and the horizontal part M-h′ thereafter) correspond to the negative scanning polarity. In the (M+1)^{th} sub-period, the falling edge slope (M+1)-a′ (and the horizontal part (M+1)-b′ thereafter), the falling edge slope (M+1)-e′ (and the horizontal part (M+1)-f′ thereafter), and the falling edge slope (M+1)-i′ (and the horizontal part (M+1)-j′ thereafter) correspond to the negative scanning polarity, and the rising edge slope (M+1)-c′ (and the horizontal part (M+1)-d′ thereafter), and the rising edge slope (M+1)-g′ (and the horizontal part (M+1)-h′ thereafter) correspond to the positive scanning polarity.

In this manner, the M^{th} sub-period and the (M+1)^{th} sub-period respectively include canning stages with the same length and opposite scanning polarities. That is, in an embodiment as shown in FIG. 1, the first sub-period and the second sub-period respectively include 3 trapezoidal wave edge slopes (the first sub-period includes 2 rising edges and 1 falling edge, and the second sub-period includes 2 falling edges and 1 rising edge). Similarly, the M^{th} sub-period and the (M+1)^{th} sub-period respectively include 5 trapezoidal wave edge slopes (the M^{th} sub-period includes 3 rising edges and 2 falling edges, and the (M+1)^{th} sub-period includes 3 falling edges and 2 rising edges). In addition, in another embodiment as shown in FIG. 2, each sub-period includes 1 trapezoidal wave edge slope (the first sub-period includes 1 rising edge, and the second sub-period includes 1 falling edge. Similarly, the M^{th} sub-period includes 1 rising edge, and the (M+1)^{th} sub-period includes 1 falling edge). In general, when the waveform change direction of the scanning signal corresponds to the scanning polarity, the scanning signal of each sub-period may include an odd number of trapezoidal wave edge slopes or an odd number of square wave edge slopes, corresponding to the same number of scanning polarity switches.

In addition, it should be noted that the number of edge slopes included in the scanning signal of different sub-periods may be the same (for example, the number of edge slopes in the first sub-period and that in the M^{th} sub-period in FIG. 2 are the same), or different (for example, the number of edge slopes in the first sub-period and that in the M^{th} sub-period in FIG. 1 are different). A duration of the scanning stages in different sub-periods may be the same (for example, the duration of the scanning stage in the first sub-period and that in the M^{th} sub-period in FIG. 2 are the same), or different (for example, the duration of the scanning stage in the first sub-period and that in the M^{th} sub-period in FIG. 1 are different). The durations of the scanning stages in the same sub-period may be the same (for example, the durations of the scanning stages in the first sub-period in FIG. 1 are the same), or different (for example, the durations of the scanning stages in the M^{th} sub-period in FIG. 1 are different). As long as the correspondence between the scanning signal and the scanning polarity is satisfied, the method of this disclosure can be implemented.

In summary, in the common-mode interference elimination method for the scanning detection device provided in the above embodiments of this disclosure, the scanning period of the scanning detection device is set to include N sub-periods each of which is integer multiples of the period of the interference signal, the M^{th} sub-period and the (M+1)^{th} sub-period respectively including scanning stages with the same length and opposite scanning polarities, N is a positive even number, K is a natural number, and M=1, 3, . . . , and N−1, to make the influence of the interference signal during the scanning process on the scanning result be self-cancelled. In this manner, disadvantages caused by common-mode interference, such as touch failure or fingerprint recognition failure, may be alleviated, and usage performance of the scanning detection device, such as a capacitive touch screen or a capacitive fingerprint recognition device, may be improved. In the embodiments of this disclosure, no complex circuit structure is needed, and merely the scanning period and scanning polarity of the scanning detection device need to be reasonably set according to the period of the interference signal. The embodiments of this disclosure are applicable to common-mode interference systems of various interference frequencies, and have low implementation difficulty, low cost and good effect.

In FIG. 3, a common mode interference signal of a scanning detection device (such as a capacitive touch screen or a capacitive fingerprint recognition device) typically has different waveforms, and the most common interference signal 201 in the form of a sine wave is shown here as an example. Those skilled in the art could understand that what is applicable to the sine wave 201 can also be applicable to each odd harmonic of the sine wave 201.

This disclosure provides a common-mode interference elimination method for a scanning detection device, wherein a scanning period of the scanning detection device is set to N sub-periods each of which is (K+0.5) times of a period of the interference signal, wherein N is a positive even number, and K is a natural number. FIG. 1 illustrates the first sub-period, the second sub-period, the M^{th} sub-period and the (M+1)^{th} sub-period as an example, M=1, 3, . . . , N−1. In the embodiment, the first sub-period and the second sub-period are 2.5 times (i.e., K=2) of the period of the interference signal 201, respectively, and the M^{th} sub-period and the (M+1)^{th} sub-period are 3.5 times (i.e., K=3) of the period of the interference signal 201, respectively. That is, the lengths of the sub-periods may be different, and as long as they are (K+0.5) times of the period of the interference signal, the method provided in this disclosure can be implemented.

Inventors of this disclosure have discovered through research and experiments that when the M^{th} sub-period and the (M+1)^{th} sub-period respectively include scanning stages with the same length and the same scanning polarity, as the interference signal has the same magnitude and different signs, influence of the interference signal during a scanning process on a scanning result can be self-cancelled. The same scanning polarity means that when the scanning polarity of a scanning stage in the M^{th} sub-period is positive, the scanning polarity of a corresponding scanning stage in the (M+1)^{th} sub-period is positive; when the scanning polarity of a scanning stage in the M^{th} sub-period is negative, the scanning polarity of a corresponding scanning stage in the (M+1)^{th} sub-period is negative; or when the scanning polarity of a scanning stage in the M^{th} sub-period is zero, the scanning polarity of a corresponding scanning stage in the (M+1)^{th} sub-period is zero.

Specifically, the positive scanning polarity means that an output signal changes in a same direction as an input signal changes, that is, the output increases as the input increases, or the output decreases as the input decreases. The negative scanning polarities mean that the output signal changes in an opposite direction as the input signal changes, that is, the output decreases as the input increases, or the output increases as the input decreases. The zero scanning polarity means that the output signal does not change with the input signal, that is, the output change is independent of the input change, and a signal path is disconnected. In a circuit, it can typically be achieved by selecting a control switch. For example, if a switch between a signal obtained by scanning and a positive input terminal of a next-stage circuit is open, and a switch between the signal obtained by scanning and a negative input terminal of the next-stage circuit is closed, the scanning polarity is positive. Otherwise, if the switch between the signal obtained by scanning and the positive input terminal of the next-stage circuit is closed, and the switch between the signal obtained by scanning and the negative input terminal of the next-stage circuit is closed, the scanning polarity is negative. If the switches between the signal obtained by scanning and the two input terminals of the next-stage circuit are closed, it is zero polarity. Each of the sub-periods nay include one or more scanning stages with the scanning polarity of positive, negative or zero. As long as the M^{th} sub-period and the (M+1)^{th} sub-period respectively include scanning stages with the same length and the same scanning polarity, the method of this disclosure can be implemented.

As the interference signal 201 is a periodic signal with 0.5 period as a boundary and presents central symmetry before and after, when the M^{th} sub-period and the (M+1)^{th} sub-period are respectively (K+0.5) times of the period of the interference signal, and the M^{th} sub-period and the (M+1)^{th} sub-period respectively include scanning stages with the same length and the same scanning polarity, the interference signal in each corresponding stage has the same magnitude and opposite signs, which makes influence of the interference signal during a scanning process on a scanning result be self-cancelled, thereby alleviating disadvantages caused by common mode interference, such as touch failure or fingerprint recognition failure, and improving usage performance of the scanning detection device, such as a capacitive touch screen or a capacitive fingerprint recognition device.

Therefore, in the embodiments of this disclosure, no complex circuit structure is needed, and merely the scanning period and scanning polarity of the scanning detection device need to be reasonably set according to the period of the interference signal. The embodiments of this disclosure are applicable to common-mode interference systems of various interference frequencies, and have low implementation difficulty, low cost and good effect.

Those skilled in the art could understand that, in addition to sine waves, other interference signals that are periodic signals with 0.5 period as the boundary and are centrally symmetrical before and after are also suitable for elimination by the method of this disclosure.

In an embodiment of this disclosure, the scanning polarity of the scanning detection device may be unassociated with the specific waveform of the scanning signal and the waveform change direction, that is, the scanning signal and the scanning polarity are controlled independently.

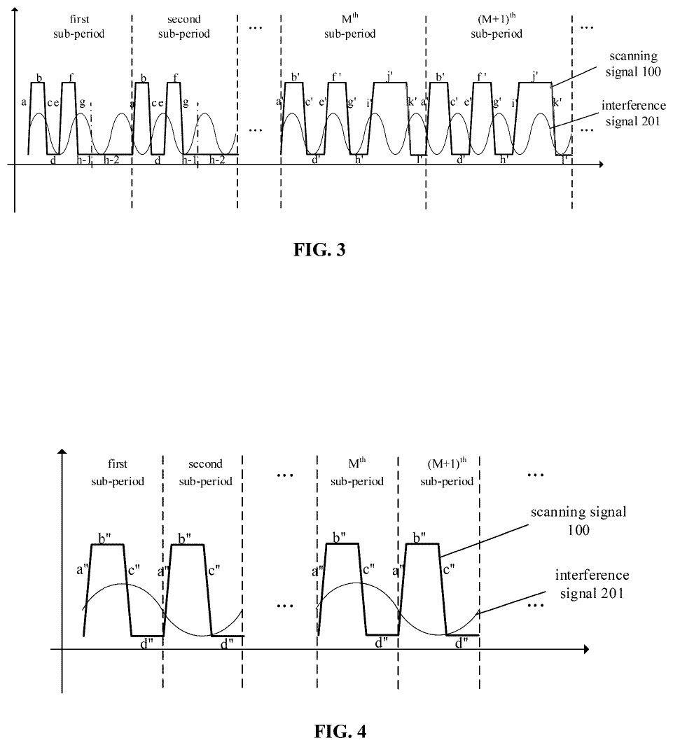

In another embodiment of this disclosure, the scanning polarity of the scanning detection device may correspond to the waveform change direction of the scanning signal, that is, the waveform change of the scanning signal and the switch of the scanning polarity are performed synchronously. In the embodiment as shown in FIG. 3, taking the scanning signal 100 of a trapezoidal wave as an example (one skilled in the art could understand that the scanning signal 100 may alternatively be a square wave or other common waveforms, which is not limited in this disclosure), the waveform change direction of the scanning signal corresponding to the scanning polarity means that a rising edge slope (and a horizontal part thereafter) of the trapezoidal wave corresponds to the positive scanning polarity, and a falling edge slope (and a horizontal part thereafter) corresponds to the negative scanning polarity; or the rising edge slope (and the horizontal part thereafter) corresponds to the negative scanning polarity, and the falling edge slope (and the horizontal part thereafter) corresponds to the positive scanning polarity. Taking the first case as an example, in the first sub-period shown in FIG. 3, the rising edge slope 1-a (and the horizontal part 1-b thereafter) and the rising edge slope 1-e (and the horizontal part 1-f-1 thereafter) correspond to the positive scanning polarity, the falling edge slope 1-c (and the horizontal part 1-d thereafter) and the falling edge slope 1-g (and the horizontal part 1-h-1 thereafter) correspond to the negative scanning polarity, and the horizontal part 1-h-2 corresponds to zero scanning polarity. In the second sub-period, the rising edge slope 2-a (and the horizontal part 2-b thereafter) and the rising edge slope 2-e (and the horizontal part 2-f-1 thereafter) correspond to the positive scanning polarity, the falling edge slope 2-c (and the horizontal part 2-d thereafter) and the falling edge slope 2-g (and the horizontal part 2-h thereafter) correspond to the negative scanning polarity, and the horizontal part 2-h-2 corresponds to zero scanning polarity. In this manner, the first sub-period and the second sub-period respectively include scanning stages with the same length and the same scanning polarity. In the M^{th} sub-period, the rising edge slope M-a′ (and the horizontal part M-b′ thereafter), the rising edge slope M-e′ (and the horizontal part M-f thereafter), and the rising edge slope M-i′ (and the horizontal part M-j′ thereafter) correspond to the positive scanning polarity, and the falling edge slope M-c′ (and the horizontal part M-d′ thereafter), the falling edge slope M-g′ (and the horizontal part M-h′ thereafter), and the falling edge slope M-k′ (and the horizontal part M-l′ thereafter) correspond to the negative scanning polarity. In the (M+1)^{th} sub-period, the rising edge slope (M+1)-a′ (and the horizontal part (M+1)-b′ thereafter), the rising edge slope (M+1)-e′ (and the horizontal part (M+1)-f′ thereafter), and the rising edge slope (M+1)-i′ (and the horizontal part (M+1)-j′ thereafter) correspond to the positive scanning polarity, and the falling edge slope (M+1)-c′ (and the horizontal part (M+1)-d′ thereafter), the falling edge slope (M+1)-g′ (and the horizontal part (M+1)-h′ thereafter), and the falling edge slope (M+1)-k′ (and the horizontal part (M+1)-l′ thereafter) correspond to the negative scanning polarity. In this manner, the M^{th} sub-period and the (M+1)^{th} sub-period respectively include scanning stages with the same length and the same scanning polarity. That is, in an embodiment as shown in FIG. 3, the first sub-period and the second sub-period respectively include 4 trapezoidal wave edge slopes (2 rising edges and 2 falling edges). Similarly, the M^{th} sub-period and the (M+1)^{th} sub-period respectively include 6 trapezoidal wave edge slopes (3 rising edges and 3 falling edges). In addition, in another embodiment as shown in FIG. 4, each sub-period includes 2 trapezoidal wave edge slopes (1 rising edge and 1 falling edge, and K−0). In general, when the waveform change direction of the scanning signal corresponds to the scanning polarity, the scanning signal of each sub-period may include an even number of trapezoidal wave edge slopes or an even number of square wave edge slopes, corresponding to the same number of scanning polarity switches.

In addition, it should be noted that the number of edge slopes included in the scanning signal of different sub-periods may be the same (for example, the number of edge slopes in the first sub-period and that in the M^{th} sub-period in FIG. 4 are the same), or different (for example, the number of edge slopes in the first sub-period and that in the M^{th} sub-period in FIG. 3 are different). Durations of the scanning stages in different sub-periods may be the same (for example, the duration of the scanning stage in the first sub-period and that in the M^{th} sub-period in FIG. 4 are the same), or different (for example, the duration of the scanning stage in the first sub-period and that in the M^{th} sub-period in FIG. 3 are different). Durations of the scanning stages within the same sub-period may be the same (for example, the durations of the scanning stages within the first sub-period in FIG. 3 are the same), or different (for example, the durations of the scanning stages within the M^{th} sub-period in FIG. 3 are different). As long as the correspondence between the scanning signal and the scanning polarity is satisfied, the method of this disclosure can be implemented.

In summary, in the common-mode interference elimination method for the scanning detection device provided in the above embodiments of this disclosure, the scanning period of the scanning detection device is set to include N sub-periods each of which is (K+0.5) times of the period of the interference signal, the M^{th} sub-period and the (M+1)^{th} sub-period respectively including scanning stages with the same length and the same scanning polarity, N is a positive even number, K is a natural number, and M=1, 3, . . . , and N−1, to make the influence of the interference signal during the scanning process on the scanning result be self-cancelled. In this manner, disadvantages caused by common-mode interference, such as touch failure or fingerprint recognition failure, may be alleviated, and usage performance of the scanning detection device, such as a capacitive touch screen or a capacitive fingerprint recognition device, may be improved. In the embodiments of this disclosure, no complex circuit structure is needed, and merely the scanning period and scanning polarity of the scanning detection device need to be reasonably set according to the period of the interference signal. The embodiments of this disclosure are applicable to common-mode interference systems of various interference frequencies, and have low implementation difficulty, low cost and good effect.

It is clear to those skilled in the art that this disclosure is not limited to the details of the exemplary embodiments described above, and that this disclosure can be implemented in other specific forms without departing from the spirit or essential features of this disclosure. Therefore, in any case, the embodiments should be regarded as exemplary and non-restrictive. In addition, it is clear that the word “including” does not exclude other elements and steps, and the wording “a” does not exclude the plural. Multiple elements stated in the device claim may also be implemented by one element. The words first, second, etc. are used to indicate names, and do not indicate any particular order.

1. A common-mode interference elimination method for a scanning detection device,
wherein in response to an M^{th} sub-period and an (M+1)^{th} sub-period respectively comprising scanning stages with a same length and a same scanning polarity, setting a scanning period of the scanning detection device to comprise N sub-periods that are (K+0.5) times a period of an interference signal, to make influence of the interference signal during a scanning process on a scanning result be self-cancelled, wherein M=1, 3, . . . , N−1, N is a positive even number, and K is a natural number; or
in response to the M^{th} sub-period and the (M+1)^{th} sub-period respectively comprising scanning stages with the same length and opposite scanning polarities, setting the scanning period of the scanning detection device to comprise N sub-periods that are K times the period of the interference signal, to make the influence of the interference signal during the scanning process on the scanning result be self-cancelled, wherein M=1, 3, . . . , N−1, N is a positive even number, and K is a positive integer;
wherein two scanning stages with the same scanning polarity mean that scanning polarities of the two scanning stages are both positive or both negative, and two scanning stages with opposite scanning polarities mean that the scanning polarity of one scanning stage is positive, and the scanning polarity of the other scanning stage is negative.

2. The method according to claim 1, wherein the positive scanning polarity means that an output signal changes in a same direction as an input signal changes, and the negative scanning polarity means that the output signal changes in an opposite direction as the input signal changes.

3. The method according to claim 1, wherein each of the sub-periods comprises one or more scanning stages with a scanning polarity of positive or negative.

4. The method according to claim 1, wherein in two scanning stages with the same scanning polarity, amplitudes of the interference signal are equal and signs of the interference signal are opposite, to make influence of the interference signal on output cancel each other out after the scanning stages with the same scanning polarity; and in two scanning stages with opposite scanning polarities, the amplitudes of the interference signal are equal and the signs of the interference signal are the same, to make the influence of the interference signal on the output cancel each other out after the scanning stages with the opposite scanning polarities.

5. (canceled)

6. The method according to claim 1, wherein in response to the scanning polarities being the same, the interference signal comprises a fundamental wave and odd harmonics, and in response to the scanning polarities being opposite, the interference signal comprises the fundamental wave, odd harmonics, and even harmonics.

7. The method according to claim 1, wherein a scanning signal of the scanning detection device is a trapezoidal wave or a square wave.

8. The method according to claim 7, wherein a waveform change direction of the scanning signal corresponds to the scanning polarity; or
wherein a waveform change direction of the scanning signal is unassociated with the scanning polarity

9. The method according to claim 8, wherein each of the sub-periods comprises an even number of trapezoidal wave edge slopes or an even number of square wave edge slopes, and two sub-periods having the same scanning polarities correspond to a same number of scanning polarity switches; or, each of the sub-periods comprises an odd number of trapezoidal wave edge slopes or an odd number of square wave edge slopes, and two sub-periods having opposite scanning polarities correspond to a same number of scanning polarity switches.

10. (canceled)

11. A common-mode interference elimination method for a scanning detection device, wherein a scanning period of the scanning detection device is set to comprise N sub-periods each of which is (K+0.5) times of a period of an interference signal, an M^{th} sub-period and an (M+1)^{th} sub-period respectively comprising scanning stages with a same length and a same scanning polarity, N is a positive even number, K is a natural number, and M=1, 3, . . . , and N−1, to make influence of the interference signal during a scanning process on a scanning result be self-cancelled; and
the same scanning polarity means that the scanning polarity of a scanning stage in the M^{th} sub-period and the scanning polarity of a corresponding scanning stage in the (M+1)^{th} sub-period are positive, or, the scanning polarity of a scanning stage in the M^{th} sub-period and the scanning polarity of a corresponding scanning stage in the (M+1)^{th} sub-period are negative, or, the scanning polarity of a scanning stage in the M^{th} sub-period and the scanning polarity of a corresponding scanning stage in the (M+1)^{th} sub-period is zero.

12. The method according to claim 11, wherein the positive scanning polarity means that an output signal changes in a same direction as an input signal changes, the negative scanning polarity means that the output signal changes in an opposite direction as the input signal changes, and the zero scanning polarity means that the output signal does not change with the input signal.

13. The method according to claim 11, wherein each of the sub-periods comprises one or more scanning stages with a scanning polarity of positive, negative or zero.

14-15. (canceled)

16. The method according to claim 11, wherein the interference signal comprises a fundamental wave and odd harmonics.

17. (canceled)

18. The method according to claim 11, wherein a waveform change direction of a scanning signal of the scanning detection device corresponds to the scanning polarity; or
wherein the waveform change direction of the scanning signal of the scanning detection device is unassociated with the scanning polarity.

19. The method according to claim 18, wherein each of the sub-periods comprises an even number of trapezoidal wave edge slopes or an even number of square wave edge slopes, and corresponds to a same number of scanning polarity switches.

20. (canceled)

21. A common-mode interference elimination method for a scanning detection device, wherein
a scanning period of the scanning detection device is set to comprise N sub-periods each of which is K times of a period of an interference signal, an M^{th} sub-period and an (M+1)^{th} sub-period respectively comprising scanning stages with a same length and a same scanning polarity, N is a positive even number, K is a natural number, and M=1, 3, . . . , and N−1, to make influence of the interference signal during a scanning process on a scanning result be self-cancelled; and
the opposite scanning polarities mean that the scanning polarity of a scanning stage in the M^{th} sub-period is positive and the scanning polarity of a corresponding scanning stage in the (M+1)^{th} sub-period is negative, or, the scanning polarity of a scanning stage in the M^{th} sub-period is negative and the scanning polarity of a corresponding scanning stage in the (M+1)^{th} sub-period is positive, or, the scanning polarity of a scanning stage in the M^{th} sub-period is zero and the scanning polarity of a corresponding scanning stage in the (M+1)^{th} sub-period is zero.

22. The method according to claim 21, wherein the positive scanning polarity means that an output signal changes in a same direction as an input signal changes, the negative scanning polarity means that the output signal changes in an opposite direction as the input signal changes, and the zero scanning polarity means that the output signal does not change with the input signal.

23. The method according to claim 21, wherein each of the sub-periods comprises one or more scanning stages with a scanning polarity of positive, negative or zero.

24-25. (canceled)

26. The method according to claim 21, wherein the interference signal comprises a fundamental wave and multiple harmonics.

27. (canceled)

28. The method according to claim 21, wherein a waveform change direction of a scanning signal of the scanning detection device corresponds to the scanning polarity, or
wherein the waveform change direction of the scanning signal of the scanning detection device is unassociated with the scanning polarity

29. The method according to claim 28, wherein each of the sub-periods comprises an odd number of trapezoidal wave edge slopes or an odd number of square wave edge slopes, and corresponds to a same number of scanning polarity switches.

30. (canceled)
